(19) United States
(12) Patent Application Publication
(10) Pub. No.: US 2007/0274750 A1
(43) Pub. Date: Nov. 29, 2007

(54) Method for Feeding Sheets in a Printing Machine

(75) Inventors: Eckhard Bauer, Schoenberg (DE); Stephan Walter Eduard Pareigis, Molfsee (DE); Uwe Weinlich, Kiel (DE); Dieter Karl-Heinz Dobberstein, Melsdorf (DE); Matthias Prinz, Felde (DE); Ralph Schoon, Wiesbaden (DE)

Correspondence Address: EASTMAN KODAK COMPANY;PATENT LEGAL STAFF, 343 STATE STREET, ROCHESTER, NY, 14650-2201, US

(73) Assignee: EASTMAN KODAK COMPANY, ROCHESTER, NY (US)

(21) Appl. No.: 10/581,593

(22) PCT Filed: Dec. 2, 2004
(86) PCT No.: PCT/EP04/13667

§ 371 Date: Feb. 5, 2007

(30) Foreign Application Priority Data
Dec. 5, 2003 (DE) 103 56 810.7

(51) Int. Cl. G03G 21/00

(52) U.S. Cl. 399/374

(57) ABSTRACT

The invention relates to a method of feeding sheets of printing material in a printing machine, preferably a digital printing machine, on a continuous loop transport means, in particular, a transport belt, which has at least one dead space section, specifically a seam, and which is preferably included in a transport path which permits the alternate selection between simplex printing and duplex printing, in which case it has been taken into account that a region, preferably the leading edge of a respective sheet on the transport means, is detected for the control of a printing process by means of a detecting device. The present invention is to solve the problem of making optimal use of space for sheets on the transport means, while avoiding detecting device errors caused by the dead space section. This problem has been solved by the present invention in that, when a sheet is fed, said sheet's region to be detected is prevented from entering into the dead space section of the transport means.

The present invention relates to a method for feeding sheets of printing material in a printing machine, preferably a digital printing machine, on a continuous loop transport means, in particular a transport belt, which has at least one dead space section, specifically a seam, and which is preferably included in a transport path which permits the alternate selection between simplex printing and duplex printing, in which case it has been taken into account that a region, preferably the leading edge of a respective sheet on the transport means, is detected for the control of a printing process by means of a detecting device.

In a printing machine of the aforementioned type, which comprises a continuous loop transport means having a seam or a similar dead space section, there is the problem that a region, in particular the leading edge of a sheet which enters precisely this dead space section, is potentially not accurately recognized or detected by the detecting device. If there is a seam, for example due to the overlapping conglutination of the ends of a transport belt, this seam could mistakenly be detected as being the leading edge of a sheet. Consequently, these so-called “collisions” between the leading edges of sheets and the dead space section, or this kind of error by the detecting device, are to be avoided. Ignoring the dead space section, this can be achieved in that the total length of the transport means is divided or split up into “windows” or “frames,” in which respectively one sheet to be printed can be placed. To achieve this, these frames are of a size generous enough that the largest, theoretically occurring sheet format plus a required minimum distance from the subsequent sheet, would fit into said frame. In doing so, these “frames” could be understood and interpreted as length sections on the transport means, or also as the feed time section for feeding a sheet.

However, this careful budgeting of space on the transport means has the result that the printing machine is not utilized in an economical manner.

Therefore, it is an object of the present invention to solve the problem of making optimal use of the space for sheets on the transport means, while avoiding detecting device errors caused by the dead space section.

This problem has been solved by the present invention in that, when a sheet is fed, said sheet's region to be detected is prevented from entering into the dead space section of the transport means.

As a result of this inventive measure, it has been advantageously achieved that, for example, each leading edge of a sheet can be detected well outside the dead space section. Preferably, this is achieved in that the feed time for a sheet, whose region to be detected would be within the dead space section, is delayed by a period of time which corresponds to the size of the dead space section in transport direction divided by the transport speed of the transport means.

In accordance with a further modification of the present invention, it should preferably also be avoided that, when feeding a sheet for obverse printing, said sheet or its region to be detected moves into a section to be occupied by a sheet that is to backed or perfected. Preferably, this is achieved in that the feed time for the sheet, which or whose region to be detected would coincide with the section of the sheet to be backed or perfected, is delayed by a time which corresponds (as a rule, at most) to the size of this section in transport direction divided by the transport speed of the transport means.

Especially when considering potential collisions of all the sheets, it will not be sufficient, as a rule, that the region to be detected, namely, for example, the leading edge of the planned sheet, will not enter the section of the other sheet but that the entire section of the planned sheet is not allowed to intersect or overlap with the section of the other sheet. In doing so, it becomes clear that, in accordance with the present invention, it is not only absolutely necessary that only one feed time needs to be planned and is being planned, but that, preferably, one time interval of the planned sheet will be considered, and that it is ensured that this time interval does not overlap with another time interval assigned to a dead space section or to another sheet.

In all, the present invention is to ensure that, in duplex printing, the feed time for printing the obverse side of a sheet is coordinated with the feed time for printing the reverse side of the same sheet, or that care is taken that collisions are prevented during both passes of the sheet. This means, for example, that if the leading edge of a sheet to be printed on the reverse side were to enter the dead space section, not only the way that sheet is fed would be changed or taken into consideration, but also the feeding of the same sheet's associate back-page would be taken into consideration in view of this feeding correction and would lead to a corresponding or appropriate change. If this should cause the leading edge of the obverse side to enter the dead space section, this would, in turn, be taken into consideration during the correction of the feeding motions.

Furthermore, the present invention prevents the sheets of a duplex printing order from being mixed with the sheets for a simplex printing order at the time the sheets are fed.

During the feeding and placing of sheets which, of course, may have different formats, it must be borne in mind, considering the section occupied by a sheet, that said sheet's length in transport direction, and the necessary distance from the subsequent sheet, are taken into account. In addition, sufficient space or sufficient time between sheets should be taken into account; for example, additional space for register marks on the transport means for the section of a sheet should be considered, and/or the duration of time for the section of a sheet multiplied by the transport speed should be additionally considered, which requires that the printing machine be set up for the sheets' preparation, or for said machine's resetting in response to control information for its function as part of the printing process.

When an appropriate distribution of sheets has been planned, it is also desirable and intended that, if the transport means is (fully) loaded, the sections to be occupied by the sheets between the dead space section and said dead space section's return after one transport means cycle are uniformly distributed over the transport means, or at least the remaining space on the transport means which has not been occupied by printing material is minimized.

The drawings show embodiments with additional inventive features which, however, are no limitation of the scope of the invention. They show:

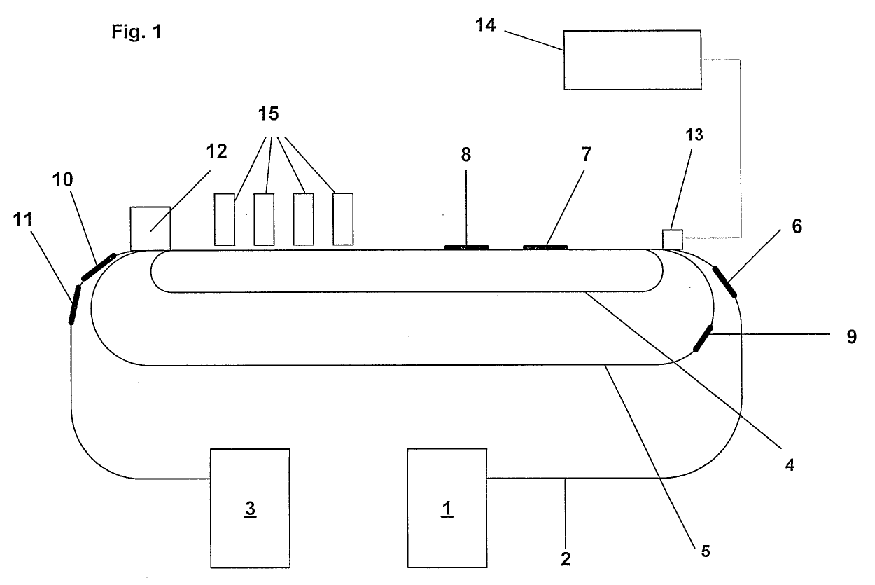

FIG. 1 a schematic side elevation of a part of a printing machine for carrying out the inventive method;

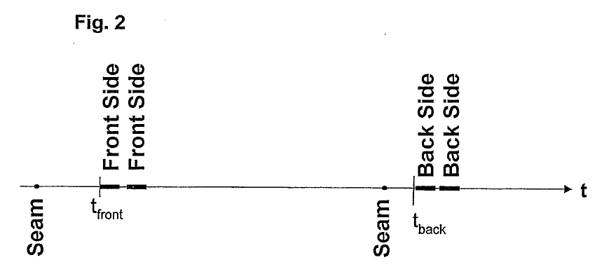

FIG. 2 a timeline represented as a one-dimensional coordinate system to explain an inventive sheet feeding operation;

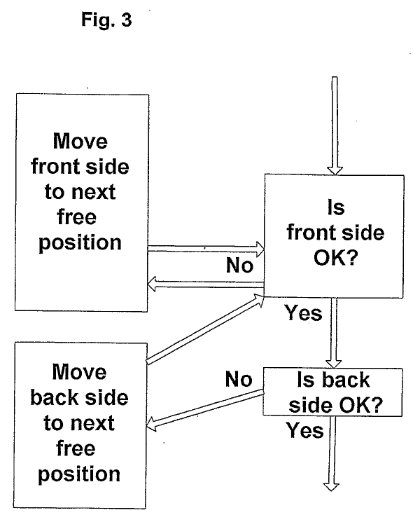

FIG. 3 a flow chart to illustrate an inventive algorithm;

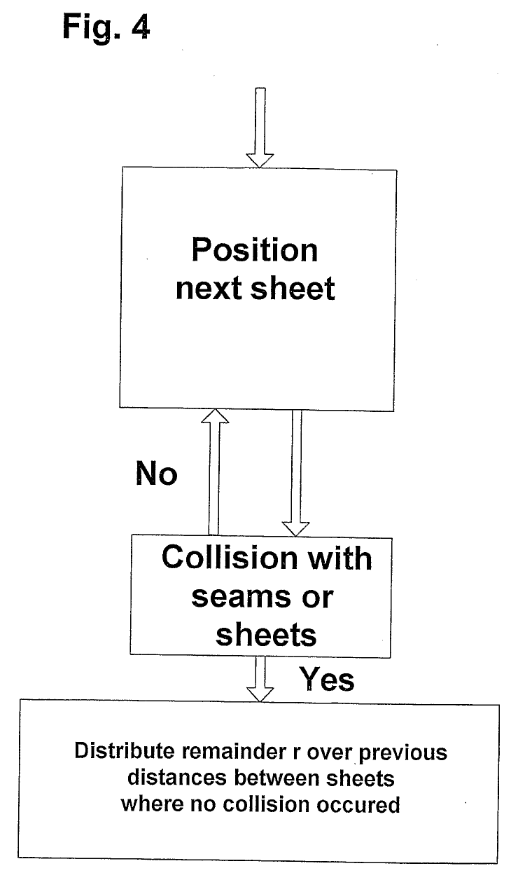

FIG. 4 another flow chart to illustrate an inventive algorithm; and,

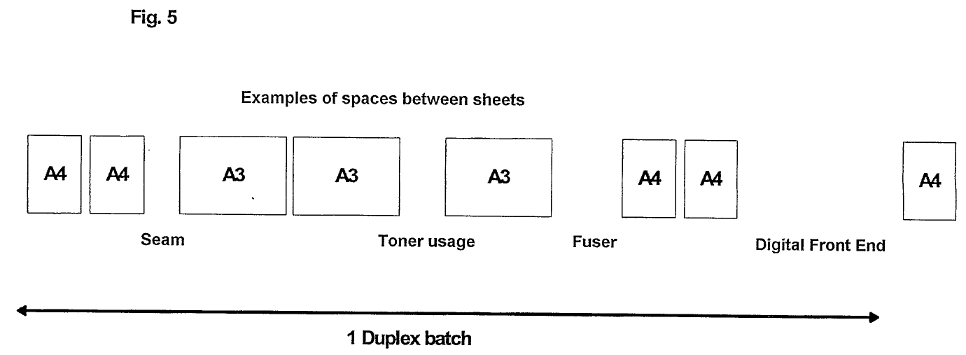

FIG. 5 an example of an inventive arrangement of sheets on a transport belt in plan view, taking into consideration different sheet formats and different reasons for dimensioning intermediate spaces between consecutive sheets.

FIG. 1 shows a schematic side elevation of a part of a printing machine used for carrying out the inventive method.

A feeder 1 for printing material sheets, a transport path 2 for printing material sheets and a feeder 3 for printing material sheets on a printing machine are indicated. Integral parts of the transport path are a continuous loop transport belt 4 which forms a section of transport path 2, and a duplex terminal loop 5 which alternately forms a section of transport path 2.

Examples of sheets of printing material are shown in different positions on transport path 2. One sheet 6 is just leaving feeder 1 and is getting ready to move onto transport belt 4. Sheets 7 and 8 are already on transport belt 4. One sheet 9 is present in duplex terminal loop 5. Sheets 10 and 11 have already left transport belt 4 and/or duplex terminal loop 5, and are on the way to feeder 3.

At least during their transfer from feeder 1 to transport belt 4, it is possible for a leading-edge sensor 13 to detect sheets 6 in the illustrated embodiment, said sensor being connected with a controller 14 of the printing machine which comprises a processor, for example. Arriving sheets 6 are fed in a timed manner to transport belt 4, for example, as sheets 7, 8, in such a manner that the printing machine is used in the most efficient manner possible and that, in particular, a printing unit or several color printing units 15 are used in the most efficient manner possible. Likewise, sheets 9 are (again) fed to transport belt 4 when said sheets have passed through duplex terminal loop 5, in order to now (after the their front pages have been printed or not) have their reverse sides printed with printing units 15. To do so, a sheet 9 may again be detected by leading-edge sensor 13. As a rule, however, this will not be necessary, because the cycling time of sheet 9 from leading-edge sensor 13 over transport belt 4 into duplex terminal loop 4 and through said terminal loop back to leading-edge sensor 13 may be presumed as being known, so that the first pass of a sheet through printing units 15 allows the planning of the time for said sheet's return for printing the reverse side, because, in particular during the first pass past leading-edge sensor 13, it is already known whether the just-detected sheet 6 is to be printed by simplex printing or duplex printing.

The problem of feeding a sheet 6 to transport belt 4 is that sheet 6 must not collide with a dead space section, for example a seam of transport belt 4, or with a sheet 9 coming out of the duplex terminal loop.

After the sheets have been printed with the use of printing units 15, the dye or ink is dried, for example, or toner is fixed with a fixing device 12, and then these sheets are fed—as sheets 9—to duplex terminal loop 5 or are transported further—as sheets 10, 11—to feeder 3.

In planning the feeding operation, it should be ensured in particular that enough space remains between the sheets, specifically between sheets 7, 8, in order to be able to operate printing units 15 and fixing unit 12 as continuously as possible so as to avoid any sheet jams that could potentially even cause a break-down of the printing machine. Above all, several feeders 1 may be provided which handle sheets having different formats and/or different other properties, for example, grammage (grams per square meter), i.e., features that must also be taken into consideration in sheet feeding, i.e., optionally even in view of a potentially required resetting of printing units 15 and/or fixing unit 12.

FIG. 2 shows a timeline as a one-dimensional coordinate system, in order to explain inventive sheet feeding.

A stream of paper is viewed under leading-edge sensor 13. This may be indicated at a point t on the timeline. Consequently, each leading edge of a sheet is assigned a time, namely the absolute time at which said sheet reaches leading-edge sensor 13.

At the start of the timeline, only the times of the seams of transport belt 4 are identified. These are intervals expressed in terms of [seam, seam+σ], where σ is the seam length. Hence, seams have the distance S, i.e.,
seamᵢ₊₁=seamᵢ+S.

Index “i” allows the differentiation of different passes of the seam and different sheets among each other, in particular, when successive passes or sheets “i” and “i+1” are viewed.

Now m represents the length of the sheet, including the required space between sheets and the space for calibration marks.

Now t_{front} represents a (future) point in time, at which the front side should be under leading-edge sensor 13.

Position t_{back} of the reverse side results from
t_{back}=t_{front}+d
where d represents the cycling time, i.e., the time required by a sheet from leading-edge sensor 13 back to leading-edge sensor 13 through duplex terminal loop 5. If a seam is located in one of the intervals [t_{front i+1}, t_{front i}+m] or [t_{back i+1}, t_{back i}+m], the position of the sheet must be moved to a later point in time. If the first sheet is then planned, the next sheet may follow. Now t_{front i+1}=t_{front i}+m.

The algorithm of FIG. 3 is used for positioning the sheet.

This algorithm is expressed as follows:

“Is front side OK?” Is t_{front} not in an interval [t_{back i+1}, t_{back i}+m] or not in an interval [seamᵢ₊₁, seamᵢ+σ], or does interval [t_{front i}, t_{front i}+m] not overlap with one of the aforementioned intervals?

“Is back side OK?” Is t_{back} not in an interval [seamᵢ₊₁, seamᵢ+σ], or does interval [t_{back i}, t_{back i}+m] not overlap with the aforementioned interval?

“Move front side to next free position.” Set t_{front i}=t_{back i}+m if t_{front i} in [t_{back l+1}, t_{back i}+m], and t_{front i}=seamᵢ+σ if t_{front i} in [seamᵢ₊₁, seamᵢ+σ], or if interval [t_{front i}, t_{front i}+m] overlaps with one of the aforementioned intervals. Furthermore, set t_{back i}=t_{front i}+d.

“Move back side to next free position.” Set t_{back i}=seamᵢ₊ₓ+σ and t_{front i}=t_{back i}−d.

The value of index “x” is a function of the number of cycles carried out by the transport belt while sheet ᵢ passes through the duplex terminal loop.

The above algorithm causes the distances between sheets to be irregular.

Regarding the algorithm of FIG. 4:

Assuming an x number of sheets fits between two seams, i.e., x=[S/m] (where [ ] represent Gaussian brackets). If S is not a whole number divisible by m, there is a remainder r=S−x•m. This remainder cannot be filled by a sheet. The algorithm for the uniform distribution of sheets now states that the remainder r must be distributed uniformly—between the seams—over the previous spaces between the sheets. Then, all the sheets between two seams receive the additional intermediate space r/x. The actual output of the printing machine is not reduced under these additional intermediate spaces.

The feature “collision” refers to one of the instances in which the branching “No” occurs in the algorithm for positioning. Consequently, front sides can “collide” with the seam or with a reverse side, or reverse sides can “collide” with the seam. The remainder r=min(a,b) refers to the minimum of the actual planning point of the front side to the next collision point and of the actual planning point of the reverse side to the next collision point.

For easier understanding, the algorithm for positioning sheets is described with only one fixed sheet size m. Preferably, an algorithm with variable sheet size is used. The difference with respect to the described algorithm is that during the step “move front side to next free position,” in the case of a collision with a duplex sheet 9, the value t_{front} must be raised such that duplex sheet 9 is in fact skipped. Therefore: t_{front}=t_{back}+m(t_{back}), where m is a function of t_{back}.

Likewise, the algorithm for uniform distribution is somewhat more complicated with variable sheet sizes. In this case, the first series of printing sheets must be processed up to the next collision, before sheets can in fact be planned.

FIG. 5 shows an example of an inventive arrangement of sheets 7, 8 on a transport belt 4 in plan view, taking into account various sheet formats and different reasons for dimensioning intermediate spaces between successive sheets.

For example, three paper feeders for papers having different formats or consistency may be provided. If a mixed operation of different papers is to be possible, this would have to be taken into consideration at the level where sheet feeding is controlled.

For example, specific additional times could be taken into consideration and result in different intermediate spaces between successive sheets when any of the sub-systems cannot maintain the actually desired minimum distance between the sheets. Reasons therefore could be, for example, that the fixing unit requires a certain time, for example 0.6 seconds, in order to switch from one sheet of printing material having a specific consistency to a subsequent sheet having another consistency, or that simply the change from one feeder to another feeder requires a certain time, or that toner consumption or toner application in an electro photographic module requires a certain break or “time-out,” or that the software, in particular the so-called “Digital Front End” (DFE), does not have any additional print orders (“jobs” or “batches”), and so on.

1. Method of feeding sheets of printing material in a printing machine, preferably a digital printing machine, on a continuous loop transport means, in particular a transport belt, which has at least one dead space section, specifically a seam, and which is preferably included in a transport path which permits the alternate selection between simplex printing and duplex printing, in which case it has been taken into account that a region, preferably the leading edge of a respective sheet on the transport means, is detected for the control of a printing process by means of a detecting device,
characterized in that
when a sheet is fed, its region to be detected is prevented from entering the dead space section of the transport means.

2. Method as in claim 1, characterized in that the feeding time for a sheet, which has its detectable region fall within the dead space section, is delayed by a period which corresponds to the size of the dead space section in transport direction divided by the transport speed of the transport means.

3. Method as in claim 1 or 2, characterized in that when the sheet is fed for obverse printing, said sheet, or its region to be detected, is prevented from entering a section to be occupied by a sheet to be printed on the reverse side.

4. Method as in claim 3, characterized in that the feeding time for the sheet, which is to be detected or which has a detectable region fall within the section of the sheet to be printed on the reverse side, is delayed by a period which corresponds to the size of this said section in transport direction divided by the transport speed of the transport means.

5. Method as in one of the previous claims, in particular as in claim 4, characterized in that, considering the section of a sheet, said sheet's length in transport direction and a required intermediate space relative to a subsequent sheet are taken into account.

6. Method as in claim 5, characterized in that, considering the section of a sheet, in addition, a space for register marks on the transport means is taken into account.

7. Method as in claim 5 or 6, characterized in that, considering the section of a sheet, in addition, the length of time multiplied by the transport speed, which requires a set-up of the printing machine for said sheet's preparation or said machine's resetting in response to control information for its function as part of the printing process, is taken into consideration.

8. Method as in one of the previous claims, characterized in that, for duplex printing, the feeding time of the sheet to be printed on the obverse side is coordinated with the feeding time for the same sheet to be printed on the reverse side.

9. Method as in one of the previous claims, in particular as in claim 8, characterized in that, when the sheets are fed, the mixing of a printing order consisting of sheets to be duplex-printed with sheets to be simplex-printed is prevented.

10. Method as in one of the previous claims, in particular as in claims 5 through 7, characterized in that, when the transport means is (fully) loaded between the dead space section and its return after one cycle of the transport means, the sections to be occupied by the sheets are distributed uniformly on the transport means.
